(19) United States
(12) Patent Application Publication
(10) Pub. No.: US 2026/0058586 A1
(43) Pub. Date: Feb. 26, 2026

(54) ROTOR POSITION ESTIMATION USING VARIABLE HIGH-FREQUENCY VOLTAGE INJECTION

(71) Applicant: GM GLOBAL TECHNOLOGY OPERATIONS LLC, Detroit, MI (US)

(72) Inventors: Michael MAYBERRY, Detroit, MI (US); Vinod Chowdary PEDDI, Shelby Township, MI (US)

(21) Appl. No.: 18/815,167

(22) Filed: Aug. 26, 2024

(51) Int. Cl. H02P 25/026; H02P 21/18

(52) U.S. Cl. CPC H02P 25/026; H02P 21/18; H02P 2203/03

(57) ABSTRACT

A propulsion system for a vehicle is disclosed and includes: a signal injection module configured i) obtain a speed of a motor of the vehicle, ii) based on the speed of the motor, to select a number of steps per cycle of an injection signal and determine an injection frequency of the injection signal, where the injection signal is to be injected into a fundamental voltage signal based on which the motor is driven, and iii) generate the injection signal having the selected number of steps per cycle and the determined injection frequency; and a propulsion control module configured i) to sum the fundamental voltage signal and the injection signal to provide a combined voltage signal, and iii) control the motor based on the combined voltage signal.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to power sources for electric vehicles.

Electric and hybrid vehicles include one or more power sources for supplying electrical energy to one or more electric motors. The electric motors are utilized for propulsion purposes and can also be used to reduce speed of the vehicles and recharge, for example, cells of the power sources. As an example, the electric motors may be operated as generators during regenerative braking operation to decelerate the vehicles and/or recharge the power sources.

### SUMMARY

A propulsion system for a vehicle is disclosed and includes: a signal injection module configured i) obtain a speed of a motor of the vehicle, ii) based on the speed of the motor, to select a number of steps per cycle of an injection signal and determine an injection frequency of the injection signal, where the injection signal is to be injected into a fundamental voltage signal based on which the motor is driven, and iii) generate the injection signal having the selected number of steps per cycle and the determined injection frequency; and a propulsion control module configured i) to sum the fundamental voltage signal and the injection signal to provide a combined voltage signal, and iii) control the motor based on the combined voltage signal.

In other features, the propulsion control module is configured to estimate the speed of the motor based on an output of a current sensor, where the current sensor detects current supplied to the motor.

In other features, the propulsion control module is configured to determine the speed of the motor based on an output of a position sensor, where the position sensor detects a rotor position of the motor.

In other features, the propulsion control module is configured to: detect current supplied to the motor, where the current supplied includes a fundamental current and an injection current; and estimate a rotor position of the motor based on the injection current.

In other features, the propulsion control module is configured to: separate out the injection current from the fundamental current based on the injection frequency; and estimate the rotor position based on the separated injection current.

In other features, the propulsion control module is configured to: detect current supplied to the motor and generating a current signal; convert the current signal to a d-axis and q-axis stationary current frame of reference signal; convert the d-axis and q-axis stationary current frame of reference signal to a d-axis and q-axis rotated frame of reference signal; separate out a fundamental torque component and an injection component from the d-axis and q-axis rotated frame of reference signal; estimate a position error based on the injection component; estimate a rotor position based on the position error; generate an output voltage signal based on the estimated rotor position and the combined voltage signal; and control the motor based on the output voltage.

In other features, the signal injection module changes the number of steps per cycle of the injection signal in response to a change in the speed of the motor.

In other features, the signal injection module is configured to decrease the number of steps in response to the speed of the motor increasing.

In other features, the propulsion control module is configured to: detect current supplied to the motor via a current sensor, where the current supplied includes a fundamental current and an injection current; and estimate a rotor position of the motor based on the injection current. The signal injection module is configured to adjust the number of steps based on one or more sensor characteristics including i) gain of the current sensor, ii) offset accuracy of the current sensor, iii) a signal to noise ratio of an output of the current sensor, and iv) a hysteresis of the current sensor.

In other features, the signal injection module is configured to: inject the injection signal for a direct axis of the motor in response to the speed of the motor being less than a set threshold; and refrain from injecting the injection signal in response to the speed of the motor being greater than the set threshold.

In other features, the propulsion control module is configured to: determine a status of a position sensor of the motor, the position sensor generating a signal indicative of a position of the motor; inject the injection signal for a direct axis of the motor in response to determining that the position sensor of the motor has failed; and refrain from injecting the injection signal in response to determining that the position sensor of the motor has not failed.

In other features, a method for controlling a motor of a vehicle is disclosed. The method includes: obtaining a speed of the motor; based on the speed of the motor, selecting a number of steps per cycle of an injection signal and determining an injection frequency of the injection signal, where the injection signal is to be injected into a fundamental voltage signal based on which the motor is driven; generating the injection signal having the selected number of steps per cycle and the determined injection frequency; summing the fundamental voltage signal and the injection signal to provide a combined voltage signal; and controlling the motor based on the combined voltage signal.

In other features, the method further includes estimating the speed of the motor based on an output of a current sensor, where the current sensor detects current supplied to the motor.

In other features, the method further includes determining the speed of the motor based on an output of a position sensor, where the position sensor detects a rotor position of the motor.

In other features, the method further includes: detecting current supplied to the motor, where the current supplied includes a fundamental current and an injection current; separating out the injection current from the fundamental current based on the injection frequency; and estimating a rotor position of the motor based on the injection current.

In other features, the method further includes: detecting current supplied to the motor and generating a current signal; converting the current signal to a d-axis and q-axis stationary current frame of reference signal; converting the d-axis and q-axis stationary current frame of reference signal to a d-axis and q-axis rotated frame of reference signal; separating out a fundamental torque component and an injection component from the d-axis and q-axis rotated frame of reference signal; estimating a position error based on the injection component; estimating a rotor position based on the position error; generating an output voltage signal based on the estimated rotor position and the combined voltage signal; and controlling the motor based on the output voltage.

In other features, the method further includes changing the number of steps per cycle of the injection signal in response to a change in the speed of the motor.

In other features, the method further includes decreasing the number of steps in response to the speed of the motor increasing.

In other features, the method further includes: detecting current supplied to the motor via a current sensor, where the current supplied includes a fundamental current and an injection current; estimating a rotor position of the motor based on the injection current; and adjusting the number of steps based on one or more sensor characteristics including i) gain of the current sensor, ii) offset accuracy of the current sensor, iii) a signal to noise ratio of an output of the current sensor, and iv) a hysteresis of the current sensor.

In other features, the method further includes: injecting the injection signal for a direct axis of the motor in response to at least one of i) determining the speed of the motor is less than a set threshold, and ii) determining that a position sensor of the motor has not failed; and refraining from injecting the injection signal in response to at least one of i) determining the speed of the motor is greater than the set threshold and ii) determining that the position sensor of the motor has failed.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a propulsion system including a propulsion control module with a rotor position module in accordance with the present disclosure;

FIG. 2 is a functional block diagram of a portion of the propulsion system of FIG. 1;

FIG. 3 is a functional block diagram of a portion of the propulsion system of FIG. 1 including a signal injection module and a current filter in accordance with the present disclosure;

FIG. 4 is a functional block diagram of the current filter of FIG. 3 illustrating signal inputs and outputs of the current filter;

FIG. 5 is a functional block diagram of an example of the current filter of FIG. 4;

FIG. 6 is an example plot of voltage versus time of a high-frequency 6-step per cycle injection signal;

FIG. 7 is an example plot of current versus time of d-axis and q-axis current and filtered out high-frequency component current detected as a result of injecting the high-frequency 6-step per cycle injection signal of FIG. 6;

FIG. 8 is an example plot of position error based on the high-frequency component current of FIG. 7;

FIG. 9 is an example plot of estimated rotor position based on the position error of FIG. 8;

FIG. 10 is an example high-frequency 4-step per cycle voltage injection signal over time;

FIG. 11 is an example high-frequency 6-step per cycle voltage injection signal over time;

FIG. 12 is an example high-frequency 8-step per cycle voltage injection signal over time;

FIG. 13 is an example high-frequency 10-step per cycle voltage injection signal over time;

FIG. 14 illustrates a method of operating a motor in accordance with the present disclosure; and

FIG. 15 is an example injection frequency verses steps per cycle plot in accordance with the present disclosure.

In the drawings, reference numbers may be reused to identify similar and/or identical elements.

### DETAILED DESCRIPTION

Rotor position of a motor of a vehicle is a factor used for controlling motor performance. Rotor position can be determined and used for controlling operating efficiency of the motor. For example, the rotor position can be detected via a position sensor mounted on a shaft of the rotor. The rotor position is then used to adjust application of current to coils on a stator of the motor to adjust alignment of magnetic fields of the stator and the rotor. The rotor can have permanent magnets with corresponding magnetic fields that interfere with magnetic fields generated by the coils. Timing (or phases) of the current applied to the coils is adjusted to adjust operating efficiency of the motor.

In an event of a failure in the position sensor of the motor, the position of the rotor may be estimated. A high frequency voltage signal may be injected in the voltage generated to drive the motor. Current supplied to the motor is detected via one or more current sensors. The detected current is indicative of the position of the motor. Fundamental and high frequency components of the detected current are separated. The high frequency component is then demodulated to provide an estimate in position error of the rotor of the motor. Based on this position error, the position of the motor can be determined.

As speed of the motor increases, the high-frequency signal injected into the current of the motor can interfere with harmonics of the motor. As the speed of the motor increases, harmonics of the operating frequency of the motor increase. As a result, the harmonics of the motor can align with the high-frequency injection signal. This can create noise and torque ripple in the motor, which may be result in rapid changes in vehicle speed and/or acceleration that are experienced (i.e., felt) by a driver and/or occupant of the vehicle.

The examples set forth herein include a system for estimating rotor position of a motor based on an injected voltage signal and adjusting current supplied to the motor based on the estimated rotor position. The injected voltage signal is generated based on the speed of the motor and the number of steps to be included per cycle of the injected voltage signal. In an embodiment, as the speed of the motor increases, the number of steps per cycle of the injected voltage signal is decreased. A decrease in the number of steps results in an increase in the frequency of the injected voltage, which allows for separation of the motor harmonics and the voltage injection.

The examples herein enable return to drivability in an event of a rotor position sensor failure during low-speed operation. Low-speed operation may refer to, for example, when the motor is operating at a speed that is less than or equal to 10% a maximum operating speed of the motor. Variable high-frequency voltage injection is used to estimate rotor position utilizing inductive saliency of the motor. Variable frequency injection is achieved through a series of multi-step injection waveforms that are employed to mitigate impact to torque production and to minimize noise vibration harshness (NVH) of the motor. This low-speed estimation along with a high-speed estimation may be used to provide a full speed range of estimation and drivability in case of a rotor position sensor failure.

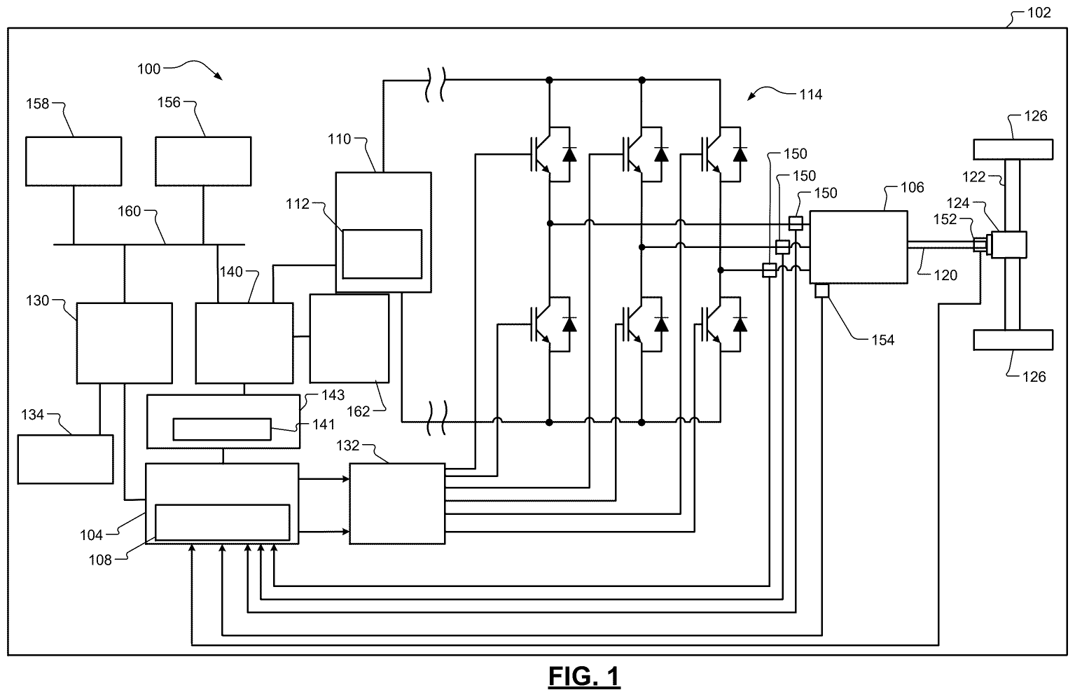

FIG. 1 shows a propulsion system 100 of a vehicle 102 that includes a propulsion control module 104 that controls operation of a motor 106. The propulsion control module 104 includes a rotor position module 108 that determines and estimates position of a rotor of the motor 106 as described further herein. This includes estimating the rotor position when the motor 106 is operating at speed below a threshold (e.g., 10% of a maximum operating speed of the motor 106).

The propulsion system 100 further includes a power source 110 including battery packs 112. The power source 110 may supply power to an inverter 114, which in turn drives the motor 106 (e.g., an interior permanent magnet (IPM) motor). Although the motor 106 is shown as an IPM motor, the motor 106 may be a surface permanent magnet motor or other type of electric motor. The power source 110 may include multiple cells, battery modules and/or battery packs that are connected in series and/or in parallel to provide predetermined voltage outputs.

The propulsion system 100 is used to move the vehicle 102 and further includes a shaft 120, an axle 122, a differential 124, and wheels 126. The inverter 114 converts a DC voltage to a three-phase alternating current (AC) to power the motor 106. The motor 106 rotates the shaft 120, which in turn rotates the axle 122 via the differential 124.

The propulsion system 100 further includes a vehicle control module 130, the propulsion control module 104 and a driver 132. The vehicle control module 130 may generate a torque request signal. The torque request signal may be generated based on torque commanded, for example, by an accelerator 134 if included. The propulsion control module 104 may control the driver 132 based on the torque request signal. The driver 132 may, for example, generate pulse width modulation (PWM) signals to control states of transistors of the inverter 114 based on output of the propulsion control module 104.

The propulsion system 100 may include a battery management module 140 that detects current and voltage levels of the one or more power sources to determine impedance responses of the one or more power sources. A different frequency signal (or pulsed signal) may be experienced by different cells, battery modules and/or battery packs based on selective coupling of the cells, battery modules and/or battery packs to the inverter. As an example, each battery module may have a respective chemical makeup, size, shape, etc. and thus be allocated a respective set of one or more frequency signals. Each frequency signal may have a respective duty cycle profile, amplitude profile, and frequency profile. In one embodiment, a same set of frequency signals are generated and experienced by two or more power sources. Application of the frequency signals and monitoring of impedance responses of the power sources allows for on-board characterization analysis of the power sources. Impedances may be calculated and stored in memory 143. The battery management module 140 may store the impedance responses and/or impedance values in the memory 143.

The propulsion control module 104 controls the driver 132 based on outputs from sensors. The sensors may include current sensors (e.g., Hall Effect sensors 150), a resolver (or rotor position sensor) 152, a temperature sensor 154, and/or other sensors 156 (e.g., an accelerometer). The current sensors may include sensors other than Hall Effect sensors.

The propulsion control module 104 performs a transformation of current phase signals Ia, Ib and Ic for the three phases of the motor to current vector signals Id and Iq. The propulsion control module 104 determines how much current is flowing and how much current is needed (or requested) and modifies input current levels of the motor 106 by adjusting output voltage vector signals supplied to the driver 132. This is based on (i) the current vector signals Id, Iq, (ii) the position signal out of the resolver 152, and (iv) the torque request signal from the vehicle control module 130.

A propulsion system 100 may include one or more electric motors. Each electric motor may be used to drive one or more axles and/or one or more wheels of the vehicle 102. As an example, an electric motor may be used to drive an axle of the vehicle 102 via a differential. The vehicle control module 130, based on a torque request, may signal the electric motor to rotate an input gear of the differential and as a result, the wheels attached to the axle. The vehicle control module 130 may adjust current, voltage and/or power levels of the electric motor to control acceleration, deceleration and/or speed of the vehicle 102.

The propulsion system 100 further includes a telematics module 158 and power source sensors and/or status monitoring devices (referred to as power source sensors 162). The battery management module 140 may configure the power source 110 based on output of the above-stated sensors, speed requests, current traveling speed, torque requests, charge states of battery packs of the power source 110, etc. The power source sensors 162 may include voltage sensors, current sensors, and/or other circuit elements used to monitor open circuit voltages (VOCs), SOCs and/or capacities of the battery packs 112 and/or cells and/or modules of the battery packs 112. The power source sensors 162 may be separate from the battery packs 112 or included in the battery packs 112 and monitor voltages, current levels, SOCs, VOCs, capacities, etc. of cells and/or modules of the battery packs and/or each of the battery packs 112 as a whole unit. The battery management module 140 may isolate one or more cells and/or battery packs 112 when: operating inappropriately; not charging to a predetermined voltage level; outputting a voltage and/or an amount of current at level(s) below predetermined minimum level(s); and/or exhibiting another abnormality. The modules 130, 140, 158, 162 and sensors 156 may be connected and/or communicate with each other via a network 170 or other form of communication.

The rotor position module 108 may be configured as any of the rotor position modules described herein and execute the method of FIG. 14.

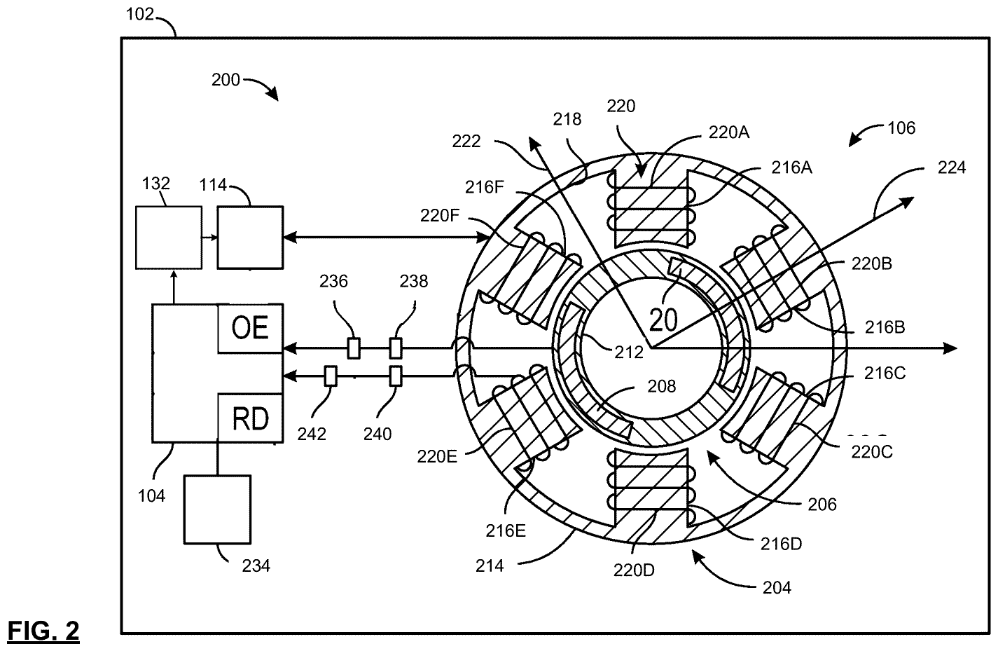

FIG. 2 shows a propulsion system 200 within the vehicle 102. The vehicle 102 includes the motor 106 having a stator 204, and a rotor 206 which includes at least one permanent magnet. The rotor 206 may include a first permanent magnet 208 and a second permanent magnet 210 of alternating polarity around the outer periphery of a rotor core 212. The rotor 206 may include any number of permanent magnets; for simplicity two are shown. The rotor 206 defines a rotor electrical speed (ωₑ) and a rotor mechanical frequency (ωₘ), which are related as (ωₑ=(P/2)*ωₘ), where P is the number of pole pairs. While the embodiment shown in FIG. 2 illustrates a three-phase, single pole pair (i.e., two poles) machine, it is understood that the number of phases or pole pairs be different than shown.

The stator 204 includes a stator core 214, which may be cylindrically shaped with a hollow interior. The stator core 214 may include inwardly protruding stator teeth 216A-F, separated by gaps or slots 218. In the embodiment shown, stator windings 220 may be operatively connected to the stator core 214, such as for example, being coiled around the stator teeth 216A-F. The motor 106 may include, but is not limited to, synchronous machines.

The stator 204 is configured to have electric current, referred to herein as stator current, flowing in the stator windings 220 and causing a rotating magnetic field in the stator 204. The stator windings 220 may include six sets of windings; one set for each of three phases (the first phase through stator windings 220A and 220D, the second phase through stator windings 220B and 220E and the third phase through stator windings 220C and 220F). Alternatively, slip rings or brushes (not shown) may be employed. A quadrature magnetic axis 222 (referred to herein as q-axis 222) and a direct magnetic axis 224 (referred to herein as d-axis 224) are shown. The first and second permanent magnets 208, 210 aid in the creation of a magnetic field and magnet flux linkage.

The propulsion system 200 includes the propulsion control module 104 in communication, such as electronic communication, with the motor 106. The propulsion control module 104 may be implemented as a standalone controller or may be implemented as a module of a vehicle and/or powertrain control module.

The propulsion control module 104 may include an online torque estimation module OE and a resolver fault detection module RD. The electric motor 12 is configured to generate torque to propel the vehicle 102. The propulsion system 200 may include a secondary source 234, such as an internal combustion engine, configured to selectively provide a secondary torque contribution to propel the vehicle 102.

The propulsion system 200 includes a position sensor 236, such as a resolver, encoder, inductive sensor or other type of detectors. The signal from the position sensor 236 provides the rotor position information which is used in many three-phase motor controls system. In case of position sensor fault, the motor control cannot maintain the torque control capability and loss of propulsion may occur in the vehicle 102. The propulsion control module 104 may include one or more processors and memory (or non-transitory, tangible computer readable storage medium) on which are recorded instructions for executing a method such as that of FIG. 14, for determining the rotor position. The memory stores controller-executable instruction sets, and the processor(s) execute the controller-executable instruction sets stored in the memory.

The system 200 is adapted to allow the torque controls at low speed, including zero speed in the event that a sensor fault condition is detected, by injecting a specific voltage signal V into the motor control system. The voltage signal V is essentially injected in the d-axis 224 in the synchronous reference frame while zero voltage is essentially injected in the q-axis 222. The injected voltage changes the shape of motor phase current according to the rotor position. The rotor position information is then calculated by the propulsion control module 104.

In order to decouple interference between rotor angle detection and fundamental torque control, it may be useful to increase the frequency of injected voltage in a scenario where the position sensor 236 is not available. The system 200 improves accuracy of rotor position estimation and enhances torque control performance, in terms of operating efficiency, maximum torque capability and torque control dynamics.

The propulsion control module 104 may execute the method of FIG. 14 and may receive inputs from one or more sensors. The propulsion system 200 may include a rotor temperature sensor 238, a current sensor 240, a magnet flux linkage observer 242, each capable of measuring a respective physical factor and sending a respective signal to the controller 230. As an alternative to physical sensors, virtual software replacements may be used. Additionally, propulsion control module 104 may be programmed to determine the respective physical factors by inputting the respective signals into a model or other estimation technique available. The driver 132 and inverter 114 may be operatively connected to the propulsion control module 104 and configured to power the motor 106.

FIG. 3 shows a portion 300 of the propulsion system 100 of FIG. 1 that includes a current generator 302, the propulsion control module 104, the driver 132, the inverter 114 and the motor 106. The propulsion control module 104 may include a current regulator 304, a first position module R(\hat{θ}) 306, and a first frame transformer 308. The current generator 302 generates a current signal

$${i}_{dq}^{{\hat{r}}^{*}}$$

(303) based on a commanded torque (or commanded current signal 301), which is provided to the current regulator 304 that outputs a fundamental voltage signal

$${v}_{dqf}^{{\hat{r}}^{*}}$$

(305). The fundamental voltage signal

$${v}_{dqf}^{{\hat{r}}^{*}}$$

is summed with a high-frequency injection signal

$${v}_{{d}_{inj}}^{{\hat{r}}^{*}}$$

(307), generated by a signal injection module 310, via a summer 312 to provide a combined voltage signal 320, which is supplied to the first position module 306. The signal injection module 310 is configured to change the number of steps per cycle of the high-frequency injection signal

$${v}_{{d}_{inj}}^{{\hat{r}}^{*}}$$

based on speed of the motor 106 and a reference frequency ωₑ (314). The summer 312 is used for low magnitude high-frequency voltage injection to excite the motor, resulting in current response that is dependent on the inductive saliency of the motor and thus rotor position.

The combined voltage signal 320 output from the summer 312 is provided to the first position module 306, which converts the received signal from being in a synchronous frame of reference to a signal being in a stationary frame of reference based on the determined or estimated rotor position \hat{θ} (366). The converted signal

$${v}_{dq}^{{s}^{*}}$$

(322) is provided to the first frame transformer 308, which transforms the signal 322 from being in a stationary d-axis and q-axis frame of reference signal to an abc (or 3-phase) frame of reference signal ν_{abc} (324). The abc (or 3-phase) frame of reference signal ν_{abc} is provided to the driver 132, which outputs control signals 326 to the inverter 114. The inverter outputs three AC signals 328 to the motor 106.

The propulsion control module 104 further includes a second frame transformer 330, a second position module R( [symbol] ) 332, a current filter 334, a demodulator 336 and a position estimation module 338. The second frame transformer 330 received a measured current signal i_{abc} (340) from the current sensor 150 and samples and converts the current signal i_{abc} to a d-axis and q-axis stationary current frame of reference signal

$${i}_{dq}^{s}$$

(342). The second position module 332 converts the d-axis and q-axis stationary current frame of reference signal

$${i}_{dq}^{s}$$

to a d-axis and q-axis rotated frame of reference signal

$${i}_{dq}^{\hat{r}}$$

(344) based on the determined or estimated rotor position \hat{θ} (366) from the position estimation module 338. In an embodiment, and when the rotor position sensor 152 of FIG. 1 has not failed, the second position module 332 converts the d-axis and q-axis stationary current frame of reference signal

$${i}_{dq}^{s}$$

to the d-axis and q-axis rotated frame of reference signal

$${i}_{dq}^{\hat{r}}$$

based on the measured and/or estimated rotor position. An estimated rotor position \hat{θ} may be used to verify the measured rotor position when the rotor position sensor 152 has not failed or may be used as a backup when the rotor position sensor 152 has failed.

A sensorless (meaning absent a rotor position sensor) algorithm implemented by collectively items 334, 336 and 338. The current filter 334 separates the fundamental current component

$${i}_{{dq}_{f}}^{\hat{r}}$$

(346) and the high-frequency current component

$${i}_{{q}_{inj}}^{\hat{r}}$$

(348) out or the a-axis ana q-axis rotated frame of reference signal

$${i}_{dq}^{\hat{r}} .$$

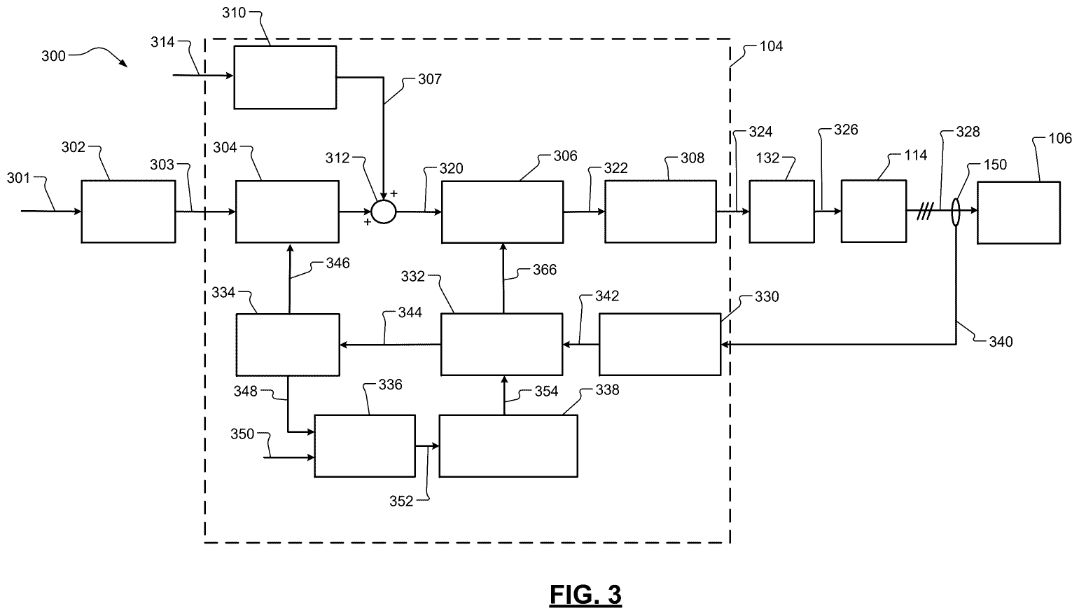

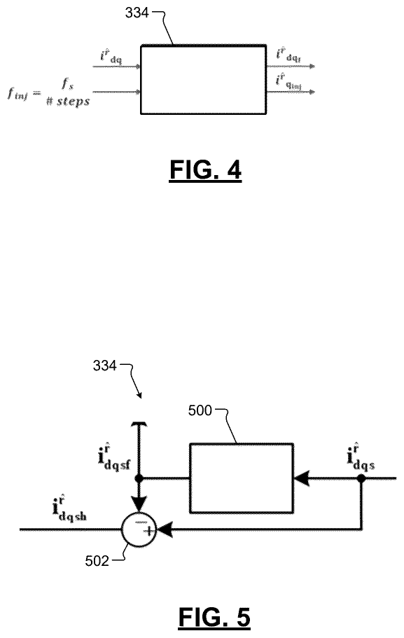

The current filter 334 is further described with respect to FIGS. 4-5. The demodulator 336 estimates rotor position error \hat{θ}ₑₛₜ (352) based on the high-frequency current component

$${i}_{{q}_{inj}}^{\hat{r}}$$

and the high-frequency injection signal

$${v}_{{d}_{inj}}^{{\hat{r}}^{*}} .$$

The output of the demodulator 336 is proportional to rotor position. In an embodiment, high-frequency current is demodulated to provide a signal proportional to position error, which is then sent into the position estimation module (or observer) 338. The position estimation module 338 estimates the rotor position \hat{θ} based on the rotor position error \tilde{θ}ₑₛₜ.

FIG. 4 shows the current filter 334 of FIG. 3. The current filter 334 receives the d-axis and q-axis rotated frame of reference signal

$${i}_{dq}^{\hat{r}}$$

and an injection frequency fᵢₙⱼ of the high-frequency injection signal

$${v}_{{d}_{inj}}^{{\hat{r}}^{*}}$$

and based on these inputs generates the fundamental current component

$${i}_{{dq}_{f}}^{\hat{r}}$$

that is used for torque production and the resultant high-frequency current component

$${i}_{{q}_{inj}}^{\hat{r}}$$

from the current injection. In an embodiment, the injection frequency fᵢₙⱼ is set equal to a sampling frequency fₛ of the motor divided by a selected number of steps per cycle of the high-frequency injection signal

$${v}_{{d}_{inj}}^{{\hat{r}}^{*}} .$$

The number of steps is selected based on the speed of the motor. The injection frequency fᵢₙⱼ changes as a function of the injection shape of the high-frequency injection signal

$${v}_{{d}_{inj}}^{{\hat{r}}^{*}} .$$

FIG. 5 shows an example of the current filter 334 of FIG. 4. The current filter 334 may include a notch filter 500 as shown or a bandpass filter and further includes a summer 502. The notch filter 500 filters the d-axis and q-axis rotated frame of reference signal

$${i}_{dq}^{\hat{r}}$$

to provide the fundamental current component

$${i}_{{dq}_{f}}^{\hat{r}} .$$

The fundamental current component

$${i}_{{dq}_{f}}^{\hat{r}}$$

is subtracted from the d-axis and q-axis rotated frame of reference signal

$${i}_{dq}^{\hat{r}}$$

to provide the resultant high-frequency current component

$${i}_{{q}_{inj}}^{\hat{r}} .$$

In an embodiment, the filter 500 has a center frequency that is set based on injection frequency of the injection signal 307 of FIG. 3 and varies dynamically as a function of shape of the injection signal 307.

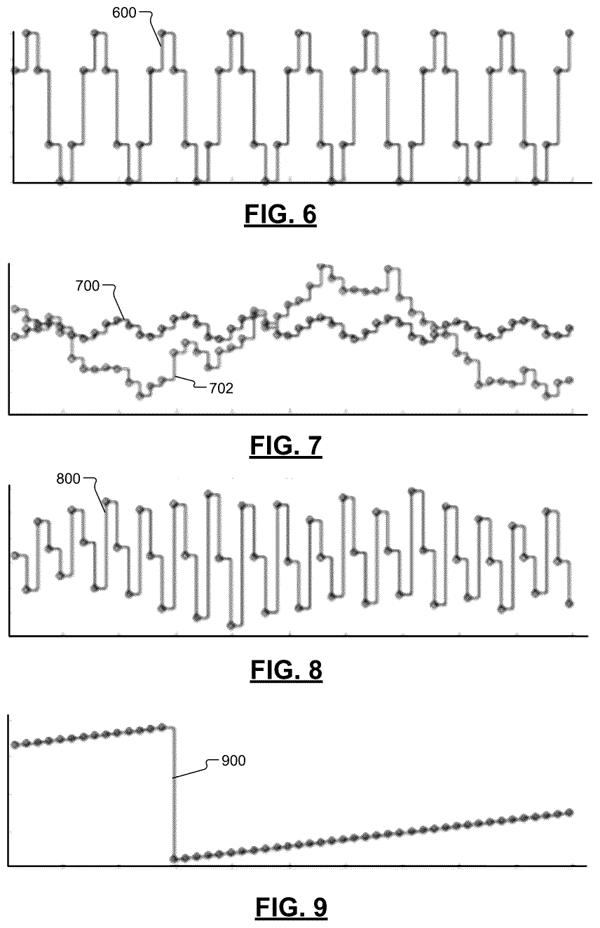

FIG. 6 shows an example plot of voltage versus time of a high-frequency 6-step per cycle injection signal 600. The injection signal 600 is generally sinusoidally shaped and includes 6 steps per cycle. This is an example of high-frequency injection signal 307 of FIG. 3.

FIG. 7 shows an example plot of current versus time of d-axis and q-axis current 700 and filtered out high-frequency component current 702 detected as a result of injecting the high-frequency 6-step per cycle injection signal of FIG. 6. The current 700 is an example of the d-axis and q-axis rotated frame of reference signal

$${i}_{dq}^{\hat{r}}$$

of FIG. 3. The current 702 is an example of the resultant high-frequency current component

$${i}_{{q}_{inj}}^{\hat{r}}$$

### of FIG. 3.

FIG. 8 shows an example plot of position error 800 based on the high-frequency component current of FIG. 7. The position error 800 is an example of the rotor position error \tilde{θ}ₑₛₜ of FIG. 3.

FIG. 9 shows an example plot of estimated rotor position based on the position error of FIG. 8. The estimated rotor position is an example of the estimated rotor position \hat{θ} of FIG. 3.

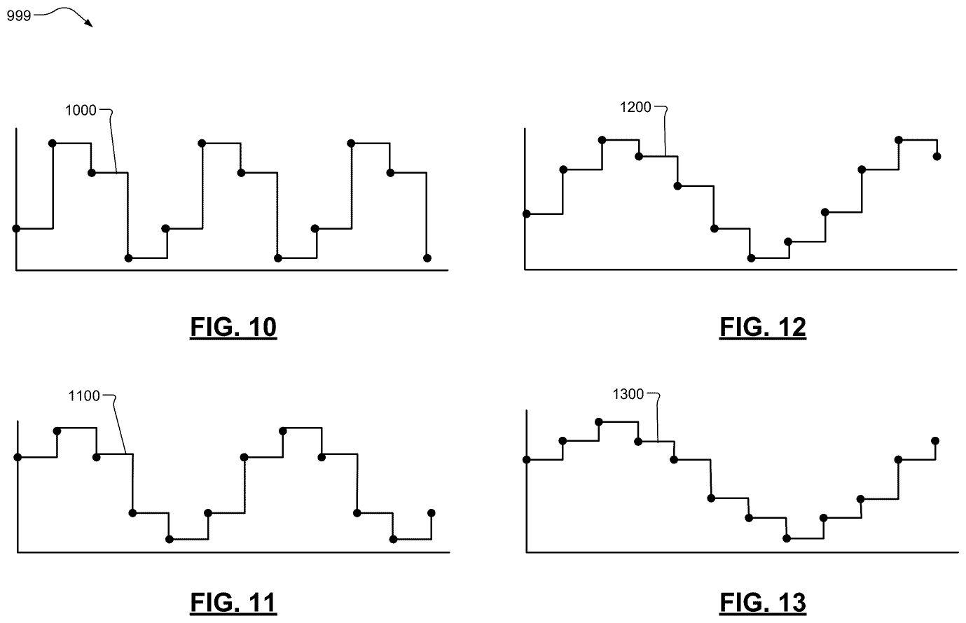

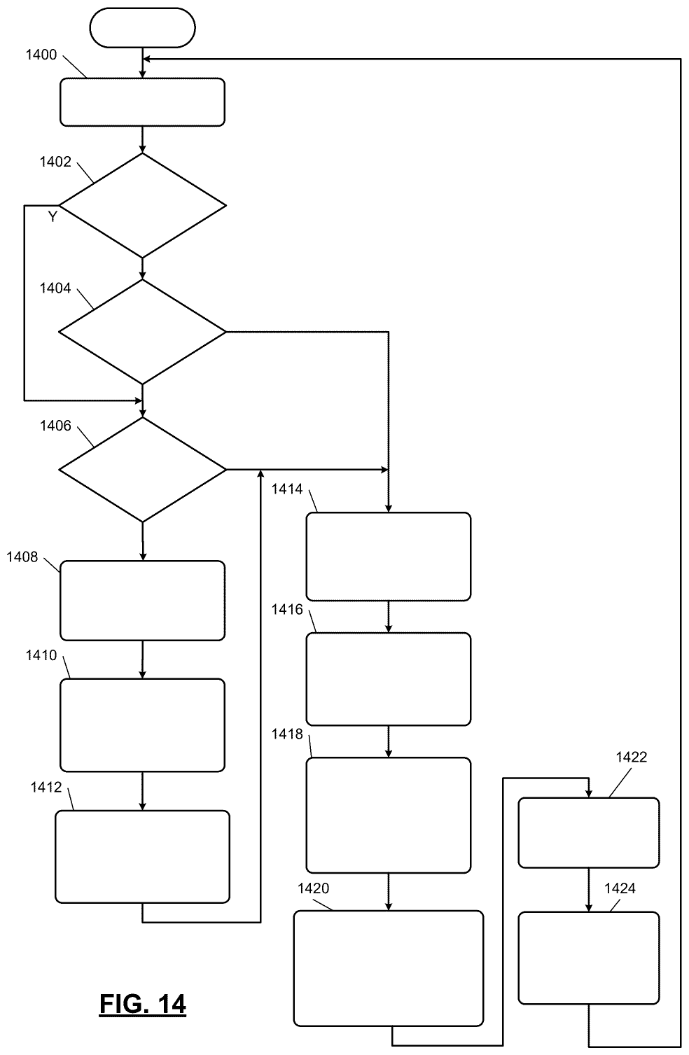

The following FIGS. 10-13 are further examples of high-frequency injection signal 307 of FIG. 3. As disclosed herein, the high-frequency injection signal 307 may be adjusted based on the speed of the corresponding motor. This may include adjusting the number of steps per cycle, the shape, and the frequency of the high-frequency injection signal. FIG. 10 shows an example high-frequency 4-step per cycle injection signal 1000. FIG. 11 shows an example high-frequency 6-step per cycle injection signal 1100. FIG. 12 shows an example high-frequency 8-step per cycle injection signal 1200. FIG. 13 shows an example high-frequency 10-step per cycle injection signal 1300. Each of the signals 1000, 1100, 1200, 1300 include discrete signal steps, where each shown dot is a start of a new step sample. Injection is provided at the level of each dot until the next step sample and thus for a respective step period. Multi-step waveforms are linked to sampling rate of current from sensors 150 of FIG. 1. The multi-step waveforms can be selected and/or varied to enable high dynamic performance to be balanced selectively with system characteristics and allow for speed dependent motor harmonics to be avoided.

FIG. 14 shows a method of operating a motor. The method may be implemented for backup operation when a rotor position sensor fails and/or for verification purposes when the rotor position sensor has not failed. The following operations may be iteratively performed. Although at least some of the following operations are performed based on speed of the motor, the operations may be performed based on output torque of the motor in addition to or as an alternative to speed.

At 1400, the speed of the motor is determined. The speed of the motor may be determined based on the rotor position sensor 154 of FIG. 1 or based on the current signals 150 of FIG. 1. In an embodiment, the speed is a last speed determined based on the output of the rotor position sensor 152 prior to detected failure of the rotor position sensor 152. In another embodiment, the speed is an estimate based on one or more of the current signals 150, which are indicative of the speed of the motor.

At 1402, the propulsion control module 104 may determine whether the rotor position is used for verification. If no, operation 1404 may be performed, otherwise operation 1406 may be performed.

At 1404, the propulsion control module 104 may determine whether the rotor position sensor 152 of FIG. 1 has failed. If yes, operation 1406 may be performed, otherwise operation 1414 may be performed.

At 1406, the propulsion control module 104 may determine whether the motor speed is less than or equal to a threshold (e.g., 10% a maximum speed of the motor). Operations 1408, 1410, 1412 may be performed as part of a low-speed method implemented from vehicle startup up to when the vehicle speed reaches the threshold. If the vehicle speed is less than or equal to the threshold, operation 1408 is performed, otherwise operation 1414 may be performed.

At 1408, the propulsion control module 104 and/or the signal injection module 310 may select a number of steps for the high-speed injection signal 307 of FIG. 3. This may be done based on the speed of the motor. The higher the speed of the motor, the lower the number of steps selected. In an embodiment, the propulsion control module 104 selects a first number of steps for a first speed range and a second number of steps for a second speed range. The first and second speed ranges are lower than the threshold used at 1406. As an example, the first number of steps is 6 for a speed range of 0-7% of a maximum speed of the motor and the second number of steps is 4 for a speed range between 7-10% of the maximum speed of the motor. Any number of speed ranges and corresponding number of steps per cycle may be implemented. For example, the four examples of FIGS. 10-13 may be implemented for four respective speed ranges between 0 and the threshold. In another example embodiment, when the speed reaches a predetermined speed (e.g., 200 revolutions per minute (rpm)), the selected number of steps is decreased. In another embodiment, the number of steps is decreased each time one of multiple speed thresholds (e.g., 200 rpm, 400 rpm, 600 rpm, etc.) are met. Although not shown in FIG. 14, the propulsion control module 104 may switch from a low-speed method as described with respect to operations 1406, 1408, 1410, 1412 to a high-speed method. This may occur when the speed reaches a predetermined speed (e.g., 1000 rpm or 2000 rpm).

As an example, a sampling frequency of 10 KHz of the motor current including a 6-step injection signal provides a 1600 Hz signal and a sampling frequency of 10 kHz of the motor current including a 4-step injection signal provides a 2500 Hz signal. Motor harmonics are multiples of motor frequency, which is directly related to motor speed. If motor speed is 2500 rpm, then the fundamental frequency is 160 Hz with harmonics, where one of the harmonics is at 1600 Hz. This depends on the number of rotor poles in the motor. Fundamental frequency is equal to the product of the number of pole pairs, motor speed (in RPM), π/30, and ½π. Thus, the number of steps may be decreased from 6 to 4 to avoid the alignment between the harmonic of the motor and the resultant sampled signal. In an embodiment, when cost of the current sensor 150 is not a concern and thus accuracy of the current sensor 150 is high, a low number of steps (e.g., 4 or less) is selected and maintained such that the number of steps is not changed as the speed of the motor is increased up to the threshold of operation 1406.

In an embodiment, when torque is used instead of speed, the number of steps may be changed based on the output torque of the motor. For example, when the output torque is less than or equal to a predetermined amount of output torque (e.g., 50% of maximum output torque of the motor), then a first number of steps is selected. When the output torque is greater than the predetermined amount of output torque, then a second number of steps is selected. The second number of steps is less than the first number of steps.

As an alternative to or in addition to adjusting the number of steps per cycle of the injection signal based on the speed of the vehicle, the number of steps per cycle may be changed based on system and/or sensor characteristics. In an embodiment, the signal injection module is configured to adjust the number of steps based on one or more sensor characteristics including i) gain of the current sensor, ii) offset accuracy of the current sensor, iii) a signal to noise ratio of an output of the current sensor, and iv) a hysteresis of the current sensor.

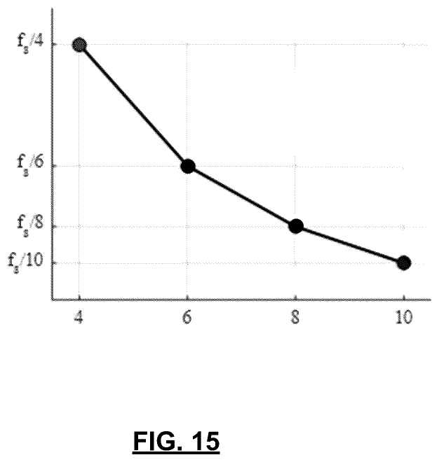

At 1410, the propulsion control module 104 and/or the signal injection module 310 may determine injection frequency fᵢₙⱼ of the high-speed injection signal based on the speed of the motor and the selected number of steps per cycle. FIG. 15 shows an example injection frequency verses steps per cycle plot. The injection frequency fᵢₙⱼ may be set equal to a sampling frequency fₛ divided by the selected number of steps. As an example, the sampling frequency fₛ may be 10 kilohertz (kHz). The injection signal is synchronized with the speed of the motor by changing and setting the number of steps based on the speed of the motor. FIG. 15 shows an example curve of injection frequency fᵢₙⱼ versus the number of signal steps per cycle. As the number of signal steps increases, associated motor noise vibration harshness (NVH) increases (or worsens). As the number of signal steps decreases, the required current sensor accuracy increases and there is less chance of motor resonance due to alignment of motor harmonics and frequency of the high-speed injection signal. The lower the number of steps selected, the higher the injection frequency fₛ. The stated factors are weighed when selecting the number of steps. The number of steps is selected such that the injection frequency fₛ is high enough where the injection signal does not align with harmonics and thus frequency content of the motor. When aligned, resonance can occur.

As an alternative or in addition to changing frequency of the injection signal based on speed of the motor, the frequency may be changed based on system and/or sensor characteristics. For example, the frequency may be changed based on i) gain of the current sensor 150, ii) offset accuracy of the current sensor 150, iii) a signal to noise ratio of an output of the current sensor 150, and iv) a hysteresis of the current sensor 150.

At 1412, the propulsion control module 104 and/or the signal injection module 310 generates and injects multi-step voltage injection signal according to determined parameters. The determined parameters include the frequency, number of steps, and shape of the injection signal.

At 1414, the second frame transformer 330 of FIG. 3 detects via the current sensor 150 the 3-phase current i_{abc} supplied to the motor.

At 1416, the second frame transformer 330 converts the 3-phase current i_{abc} to d-axis and q-axis frame stationary current frame of reference signal

$${i}_{dq}^{s} .$$

At 1418, the second position module 332 of FIG. 3 converts the d-axis and q-axis stationary current frame of reference signal

$${i}_{dq}^{s}$$

to the a-axis and q-axis rotated (synchronous) frame of reference signal

$${i}_{dq}^{\hat{r}}$$

based on the measured and/or estimated rotor position.

At 1420, the current filter 334 of FIG. 3 separates out the fundamental frequency component

$${i}_{{dq}_{f}}^{\hat{r}}$$

and the high-frequency component

$${i}_{{q}_{inj}}^{\hat{r}}$$

of the d-axis and q-axis current signal

$${i}_{dq}^{\hat{r}}$$

in the rotating frame of reference. The separating (or filtering) is performed based on the injection frequency fₛ and thus based on the selected number of steps. This allows for an accurate determination of the high-frequency component

$${i}_{{q}_{inj}}^{\hat{r}}$$

and thus subsequently accurate estimation of rotor position. Measured current is sent through a filter dynamically tuned to match the frequency of the injected voltage to separate the current used for torque from the high-frequency response to the voltage injection.

At 1422, the demodulator 336 estimates the position error \tilde{θ}ₑₛₜ of the rotor of the motor based on the high-frequency component

$${i}_{{q}_{inj}}^{\hat{r}} .$$

At 1424, the position estimation module 338 estimates the rotor position \hat{θ} based on the position error \tilde{θ}ₑₛₜ. Operation 1400 may be performed subsequent to operation 1424.

The above-described operations are meant to be illustrative examples. The operations may be performed sequentially, synchronously, simultaneously, continuously, during overlapping time periods or in a different order depending upon the application. Also, any of the operations may not be performed or skipped depending on the implementation and/or sequence of events.

The examples set forth herein include a backup method that allows for continued controlled operation of a motor when a position sensor of the rotor of the motor fails. The method includes operations that are used to control operation at low speeds (e.g., less than or equal to 10% of a maximum motor speed). These operations may be implemented in combination with operations for controlling the motor at high speeds (e.g., greater than 10% the maximum motor speed). The method includes controlled operation of the motor at the low speeds such that the motor runs efficiently.

The examples disclosed herein include varying shape of a high-frequency injection signal based on operating point of a motor (e.g., speed or output torque of the motor). This is done to avoid interaction with the fundamental frequency and its harmonics. Injection frequency is linked to the shape of the injected signal. In an embodiment, the shape is linked to an inverter switching rate and the sampling rate. In other words, the number of steps of the injection signal may be selected based on the switching rate of the inverter 114 of FIG. 1 and the sampling rate at which current supplied to the motor is sampled. The frequency of the injection signal may be increased as speed of the motor increases.

The examples include multi-step voltage injection including injection signals with an integer number of steps per cycle. The number of steps may be greater than 1. Example number of steps are 2, 4, 6, 8, 10, etc. The number of steps is tuned based on the fundamental frequency of the torque provided current of the motor and corresponding harmonics. The waveform type of the injection signal is set based on parameters such as current sensor accuracy and noise characteristic requirements. The disclosed multi-step waveforms include a discrete pattern for demodulation purposes while also being sinusoidally shaped. The magnitudes of the waveforms are held constant through step periods.

The examples provide drivability in the event of resolver failure, with little or no impact to torque capability. The examples do not impact fundamental current control (i.e., torque production).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A propulsion system for a vehicle, the propulsion system comprising:
a signal injection module configured i) obtain a speed of a motor of the vehicle, ii) based on the speed of the motor, to select a number of steps per cycle of an injection signal and determine an injection frequency of the injection signal, wherein the injection signal is to be injected into a fundamental voltage signal based on which the motor is driven, and iii) generate the injection signal having the selected number of steps per cycle and the determined injection frequency; and
a propulsion control module configured i) to sum the fundamental voltage signal and the injection signal to provide a combined voltage signal, and iii) control the motor based on the combined voltage signal.

2. The propulsion system of claim 1, wherein the propulsion control module is configured to estimate the speed of the motor based on an output of a current sensor, wherein the current sensor detects current supplied to the motor.

3. The propulsion system of claim 1 wherein the propulsion control module is configured to determine the speed of the motor based on an output of a position sensor, wherein the position sensor detects a rotor position of the motor.

4. The propulsion system of claim 1, wherein the propulsion control module is configured to:
detect current supplied to the motor, wherein the current supplied includes a fundamental current and an injection current; and
estimate a rotor position of the motor based on the injection current.

5. The propulsion system of claim 4, wherein the propulsion control module is configured to:
separate out the injection current from the fundamental current based on the injection frequency; and
estimate the rotor position based on the separated injection current.

6. The propulsion system of claim 1, wherein the propulsion control module is configured to:
detect current supplied to the motor and generating a current signal;
convert the current signal to a d-axis and q-axis stationary current frame of reference signal;
convert the d-axis and q-axis stationary current frame of reference signal to a d-axis and q-axis rotated frame of reference signal;
separate out a fundamental torque component and an injection component from the d-axis and q-axis rotated frame of reference signal;
estimate a position error based on the injection component;
estimate a rotor position based on the position error;
generate an output voltage signal based on the estimated rotor position and the combined voltage signal; and
control the motor based on the output voltage.

7. The propulsion system of claim 1, wherein the signal injection module changes the number of steps per cycle of the injection signal in response to a change in the speed of the motor.

8. The propulsion system of claim 1, wherein the signal injection module is configured to decrease the number of steps in response to the speed of the motor increasing.

9. The propulsion system of claim 1, wherein:
the propulsion control module is configured to
detect current supplied to the motor via a current sensor, wherein the current supplied includes a fundamental current and an injection current, and
estimate a rotor position of the motor based on the injection current; and
the signal injection module is configured to adjust the number of steps based on one or more sensor characteristics including i) gain of the current sensor, ii) offset accuracy of the current sensor, iii) a signal to noise ratio of an output of the current sensor, and iv) a hysteresis of the current sensor.

10. The propulsion system of claim 1, wherein the signal injection module is configured to:
inject the injection signal for a direct axis of the motor in response to the speed of the motor being less than a set threshold; and
refrain from injecting the injection signal in response to the speed of the motor being greater than the set threshold.

11. The propulsion system of claim 1, wherein the propulsion control module is configured to:
determine a status of a position sensor of the motor, the position sensor generating a signal indicative of a position of the motor;
inject the injection signal for a direct axis of the motor in response to determining that the position sensor of the motor has failed; and
refrain from injecting the injection signal in response to determining that the position sensor of the motor has not failed.

12. A method for controlling a motor of a vehicle, the method comprising:
obtaining a speed of the motor;
based on the speed of the motor, selecting a number of steps per cycle of an injection signal and determining an injection frequency of the injection signal, wherein the injection signal is to be injected into a fundamental voltage signal based on which the motor is driven;
generating the injection signal having the selected number of steps per cycle and the determined injection frequency;
summing the fundamental voltage signal and the injection signal to provide a combined voltage signal; and
controlling the motor based on the combined voltage signal.

13. The method of claim 12, further comprising estimating the speed of the motor based on an output of a current sensor, wherein the current sensor detects current supplied to the motor.

14. The method of claim 12, further comprising determining the speed of the motor based on an output of a position sensor, wherein the position sensor detects a rotor position of the motor.

15. The method of claim 12, further comprising:
detecting current supplied to the motor, wherein the current supplied includes a fundamental current and an injection current;
separating out the injection current from the fundamental current based on the injection frequency; and
estimating a rotor position of the motor based on the injection current.

16. The method of claim 12, further comprising:
detecting current supplied to the motor and generating a current signal;
converting the current signal to a d-axis and q-axis stationary current frame of reference signal;
converting the d-axis and q-axis stationary current frame of reference signal to a d-axis and q-axis rotated frame of reference signal;
separating out a fundamental torque component and an injection component from the d-axis and q-axis rotated frame of reference signal;
estimating a position error based on the injection component;
estimating a rotor position based on the position error;
generating an output voltage signal based on the estimated rotor position and the combined voltage signal; and
controlling the motor based on the output voltage.

17. The method of claim 12, further comprising changing the number of steps per cycle of the injection signal in response to a change in the speed of the motor.

18. The method of claim 12, further comprising decreasing the number of steps in response to the speed of the motor increasing.

19. The method of claim 12, further comprising:
detecting current supplied to the motor via a current sensor, wherein the current supplied includes a fundamental current and an injection current;
estimating a rotor position of the motor based on the injection current; and
adjusting the number of steps based on one or more sensor characteristics including i) gain of the current sensor, ii) offset accuracy of the current sensor, iii) a signal to noise ratio of an output of the current sensor, and iv) a hysteresis of the current sensor.

20. The method of claim 12, further comprising:
injecting the injection signal for a direct axis of the motor in response to at least one of i) determining the speed of the motor is less than a set threshold, and ii) determining that a position sensor of the motor has not failed; and
refraining from injecting the injection signal in response to at least one of i) determining the speed of the motor is greater than the set threshold and ii) determining that the position sensor of the motor has failed.
